(19) United States
(12) Patent Application Publication
(10) Pub. No.: US 2026/0141712 A1
(43) Pub. Date: May 21, 2026

(54) AI-ENABLED MACHINE VISION TASK AWARE ADAPTIVE INFERENCE

(71) Applicant: InterDigital Patent Holdings, Inc., Wilmington, DE (US)

(72) Inventors: Chonggang Wang, Princeton, NJ (US); Subhramoy Mohanti, Santa Clara, CA (US); Quang Ly, North Wales, PA (US); Dale Seed, Allentown, PA (US); Fabien Racape, San Francisco, CA (US); Lu Liu, Conshohocken, PA (US); Hyomin Choi, Sunnyvale, CA (US)

(73) Assignee: InterDigital Patent Holdings, Inc., Wilmington, DE (US)

(21) Appl. No.: 18/952,789

(22) Filed: Nov. 19, 2024

(51) Int. Cl. G06V 10/94; G06V 10/70; G06V 10/764; G06V 10/96; G06V 20/54

(52) U.S. Cl. CPC G06V 10/95; G06V 10/87; G06V 10/96; G06V 10/764; G06V 20/54; G06V 2201/08

(57) ABSTRACT

A method implemented by a wireless transmit/receive unit (WTRU) may include transmitting a request to a plurality of AI-enabled machine vision (AI-MV) servers to perform inference on an AI-MV task associated with a machine vision application. Configuration information may be received for a plurality of inference modes and may include network resource availability for executing the AI-MV task for the inference modes and processing capabilities of the AI-MV servers. An inference mode may be selected based on configuration information, network conditions detected by the WTRU, and resource availability at the WTRU. An indication of the selected inference mode and data related to the AI-MV task may be transmitted to the AI-MV servers for processing according to the selected inference mode. An inference result may be received from at least one AI-MV server in accordance with the selected inference mode. A follow-on action may be performed based on the inference result.

### BACKGROUND

Applications are becoming increasingly complex, and various mechanisms have been designed to assist with quicker development of the applications. One such mechanism involves introducing different functional layers within (or adjacent to) the application layer to separate functions that may be accessed via application programming interfaces (APIs).

### SUMMARY

A wireless transmit/receive unit (WTRU) may include a processor. The processor may be configured to transmit a request to at least one AI-enabled machine vision (AI-MV) server (e.g. a plurality of AI-MV servers) to perform inference on an AI-MV task associated with a machine vision application and receive configuration information for a plurality of inference modes. The configuration information may include network resource availability for executing the AI-MV task for each of the plurality of inference modes and processing capabilities of the plurality of AI-MV servers. The processor may be configured to select an inference mode from the plurality of inference modes based on the configuration information, network conditions detected by the WTRU, and resource availability at the WTRU, and to transmit an indication of the selected inference mode to the plurality of AI-MV servers. The processor may be configured to receive an inference result from at least one AI-MV server of the plurality of AI-MV servers generated in accordance with the selected inference mode, and to perform a follow-on action based on the inference result.

The processor may be configured to perform a follow-on action to detect an object, classify an object, track an object, adjust a navigation path of a vehicle, or modify a speed of a vehicle.

The inference result may include information indicating classifications, detections, or identifications of objects detected in an environment surrounding the WTRU.

The network conditions detected by the WTRU comprise one or more of latency, jitter, bandwidth availability, or signal strength detected at the WTRU during communication with the plurality of AI-MV servers.

The data related to the AI-MV task may include one or more of sensor input data from the WTRU, metadata associated with the input data, or task-specific parameters identifying the AI-MV task and associated sub-tasks.

The processor may be configured to determine whether to execute the AI-MV task locally at the WTRU, remotely at one or more AI-MV servers of the plurality of AI-MV servers, or in a split manner across the WTRU and the one or more AI-MV servers of the plurality of AI-MV servers to select the inference mode from the plurality of inference modes. The plurality of inference modes may include a local inference mode, a remote inference mode, and a split inference mode.

The configuration information may include information regarding available codecs at the WTRU or within the network. The processor may be configured to select the inference mode based on codec performance criteria.

The processor may be configured to select the inference mode based on energy consumption levels observed in prior inference operations. The processor may be configured to select the inference mode based on a confidence level achieved in a previous MV task result generated by the MV task AI model.

The processor may be configured to communicate with one or more AI-MV servers of the plurality of AI-MV servers to offload portions of the AI-MV task for processing in a split inference mode.

The processor may be configured to transmit a first portion of the AI-MV task to a first AI-MV server of the plurality of AI-MV severs and receive an inference result that corresponds to the first portion of the AI-MV task processed by the first AI-MV server of the plurality of AI-MV servers.

Methods implemented by a wireless transmit/receive unit (WTRU) may be described herein. The method may include transmitting a request to at least one AI-enabled machine vision (AI-MV) server (e.g. a plurality of AI-MV servers) to perform inference on an AI-MV task associated with a machine vision application. Configuration information may be received for a plurality of inference modes and may include network resource availability for executing the AI-MV task for each of the plurality of inference modes and processing capabilities of the plurality of AI-MV servers. An inference mode may be selected based on configuration information, network conditions detected by the WTRU, and resource availability at the WTRU. An indication of the selected inference mode and data related to the AI-MV task may be transmitted to the plurality of AI-MV servers for processing in accordance with the selected inference mode. An inference result may be received from at least one AI-MV server of the plurality of AI-MV servers in accordance with the selected inference mode. A follow-on action may be performed based on the inference result.

The follow-on action may include one or more of detecting an object, classifying an object, tracking an object, adjusting a navigation path of a vehicle, or modifying the speed of a vehicle.

The inference result may include information indicating classifications, detections, or identifications of objects detected in an environment surrounding the WTRU.

The network conditions detected by the WTRU may include one or more of latency, jitter, bandwidth availability, or signal strength detected at the WTRU during communication with the plurality of AI-MV servers.

The data related to the AI-MV task may include one or more of latency, jitter, bandwidth availability, or signal strength detected at the WTRU during communication with the plurality of AI-MV servers.

The method may include determining whether to execute the AI-MV task locally at the WTRU, remotely at one or more AI-MV servers of the plurality of AI-MV servers, or in a split manner across the WTRU and the one or more AI-MV servers of the plurality of AI-MV servers to select the inference mode from the plurality of inference modes. The plurality of inference modes may include a local inference mode, a remote inference mode, and a split inference mode.

The configuration information may include information regarding available codecs at the WTRU or within the network. The inference mode may be selected based on codec performance criteria.

The method may include selecting the inference mode based on energy consumption levels observed in prior inference operations, and selecting the inference mode based on a confidence level achieved in a previous MV task result generated by the MV task AI model.

The method may include communicating with one or more AI-MV servers of the plurality of AI-MV servers to offload portions of the AI-MV task for processing in a split inference mode.

The method may include transmitting a first portion of the AI-MV task to a first AI-MV server of the plurality of AI-MV server and receiving an inference result that corresponds to the first portion of the AI-MV task processed by the first AI-MV server of the plurality of AI-MV servers.

AI-enabled machine vision (MV) task-aware adaptive inference may provide task-aware adaptive MV inference across multiple devices with cascaded MV task AI models. A WTRU may request a remote or split inference for a set of multiple MV tasks, which may be executed sequentially and/or in a cascaded structure. Each MV task may have a corresponding MV task AI model (e.g., AI models). The WTRU may discover and/or contact multiple AI-MV servers, one for each MV task, or multiple AI-MV servers for one MV task, and may instruct the AI-MV servers to connect in a manner that forms a chain of requested MV tasks with cascaded AI models. Additionally, and/or alternatively, one AI-MV server may help to discover and/or contact other AI-MV servers to form a chain of requested MV tasks with cascaded AI models.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a generalized architecture that separates application development into three distinct layers: an application layer, a vertical application service layer, and a common service layer.

FIG. 3 is a diagram illustrating an example of a machine vision (MV) smart intersection.

FIG. 4 is a diagram illustrating an example of machine vision (MV) vehicle tracking.

FIG. 5 is a diagram illustrating an example organization of artificial intelligence-based machine vision (AI-MV) tasks, related sub-tasks and/or sub-processes that may influence AI-MV subnetwork management policy.

FIG. 6 is a diagram illustrating an example of an AI-enabled machine vision (AI-MV) service architecture.

FIG. 7 is a diagram illustrating an example method for MV task-aware adaptive inference (e.g., local, remote, and/or split inference) performed by an AI-MV service.

FIG. 8A is a diagram illustrating an example MV task with multiple cascaded AI models.

FIG. 8B is a diagram illustrating an example AI-MV task comprising two consecutive AI-MV sub-tasks being executed with multiple cascaded AI models located in different AI-MV servers.

FIG. 9A is a diagram illustrating an example of machine vision (MV) task Artificial Intelligence (AI) model distribution for remote split inference.

FIG. 9B is a diagram illustrating an example of AI-MV task split inferencing across an AI-MV client and multiple AI-MV servers.

### DETAILED DESCRIPTION

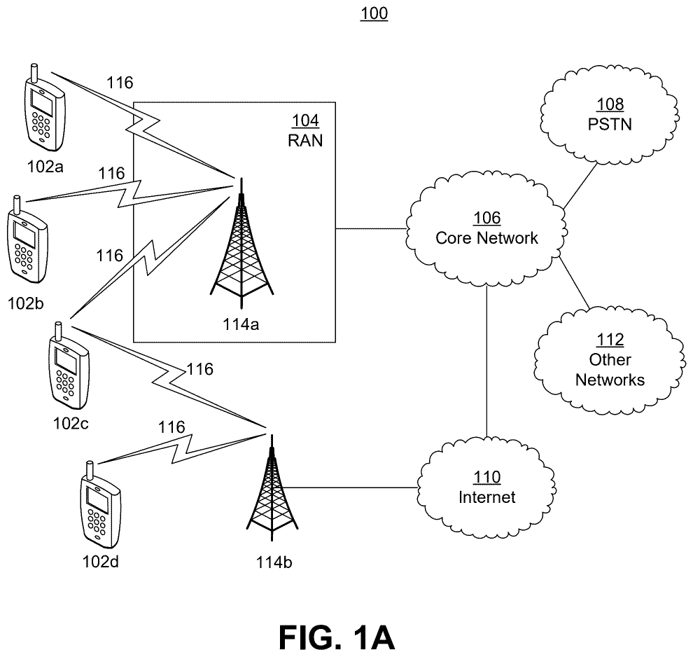

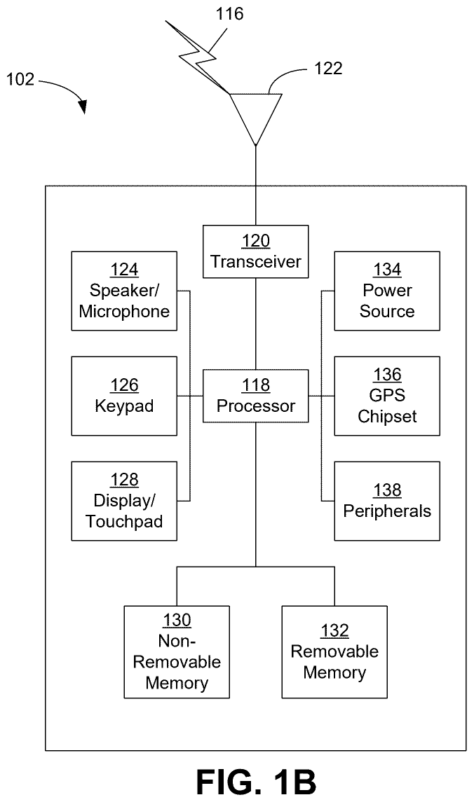

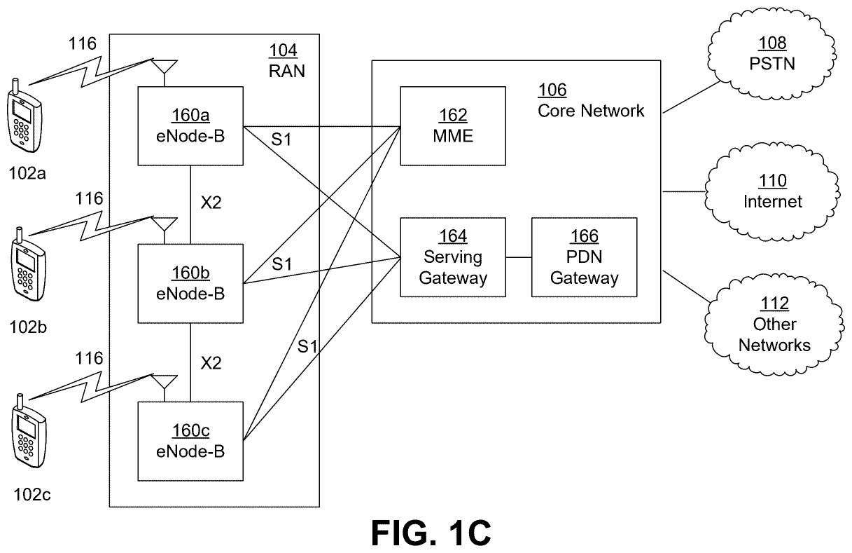

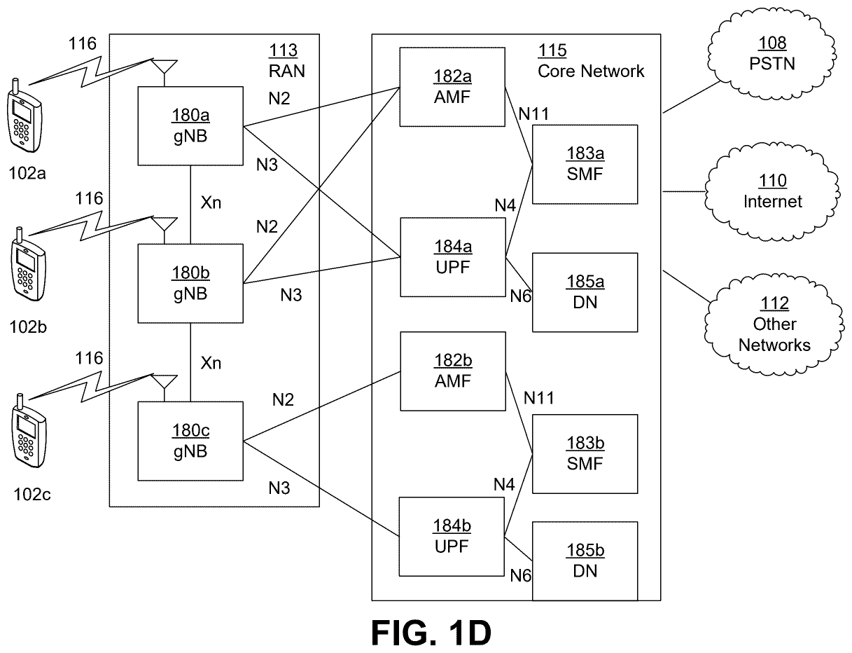

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

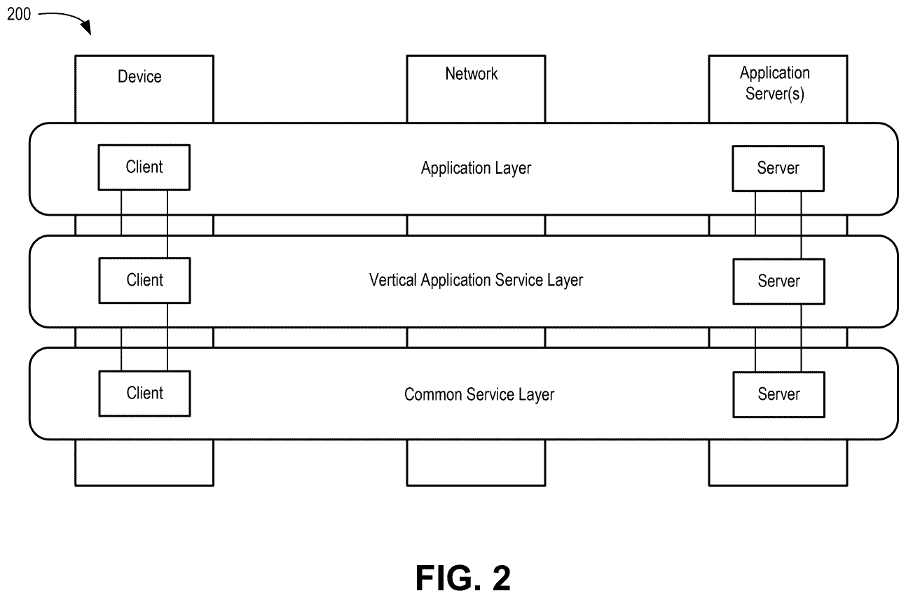

FIG. 2 is a diagram 200 illustrating an example of a generalized architecture that separates application development into three distinct layers: an application layer, a vertical application service layer, and a common service layer.

At the bottom of the application stack, a common service layer may provide common, or horizontal services to all applications. The services may include location management, group management, configuration management, and/or security aspects for application development. Above the common service layer is the vertical application service layer, which is a layer that may manage services for specific vertical applications, such as autonomous vehicles, drones, Internet of Things (IoT) systems, and/or gaming. The topmost layer of the application stack may be the application layer, where one or more applications may reside. This layer may contain custom, or business logic tailored for a particular application, and may be provided by various service providers in a vertical application domain. A goal of the three-layered architecture approach may be to abstract reusable services and applications to the common and vertical application service layers to simplify application development and/or accelerate deployment of the applications.

The service layer architecture shown in FIG. 2 may operate based on a client-server communication model, where application and service clients may communicate with their respective application and service servers. Application clients and servers may also communicate with clients and servers in upper and lower layers. For example, an application client may communicate with a vertical application service layer client or a common service layer client. A network may be utilized as a medium for communication between the client and server applications. The network may be a cellular network, such as a mobile operator network or the network may be a broadband service provider network that provides internet access for client and server applications.

The architecture shown in FIG. 2 may also apply to publish-subscribe and/or subscription-notification communication models. For decentralized deployments in which devices communicate directly with other devices, server functionality may reside on a device rather than on a network server. In such cases, devices may communicate with one another such that one device may function as a client while another device may function as a server.

A network-assisted machine vision task can be generalized as a client application running on an autonomous machine (e.g., a robot, car, unmanned aerial vehicle, and/or unmanned ground vehicle) that offloads video data to a cloud or edge server application in the network to run comparatively compute-intensive artificial intelligence/machine learning (AI/ML) based inferencing operations such as object detection, classification, and/or tracking. The cloud or edge server may send the inference results (e.g., identifying an object classified as a car, detected at a specific distance and heading in a specific direction) back to the client application via the network, in a timely manner (e.g., near real-time). The client application may then use these inference results to trigger and/or perform an action for the autonomous machine (e.g., changing speed and/or direction to avoid a collision).

Some key performance indicators for machine vision applications may be characterized by the round-trip time (e.g., from video data generation to inference feedback reception), throughput, which may depend on task type (e.g., object detection, which may include transmitting lower amounts of application data per unit of time as compared to object classification and/or tracking), the machine environment (e.g., the number of objects around the machine, object behavior such as static or mobile, and/or atmospheric conditions), and the machine behavior (e.g., mobility and/or direction).

The network demands of legacy human-type communications, such as video streaming applications (e.g., Netflix and TikTok), fundamentally differ from those of machine-type communications, such as machine vision applications (e.g., object detection and tracking for autonomous vehicles, drones, and robots). Understanding these differences is critical for designing and optimizing 5G and 6G networks to cater effectively to both human-type and machine-type communications.

Human-type communications have traditionally dominated network traffic, with video streaming being one of the most bandwidth-intensive applications. For video streaming, quality of service (QoS) may be measured by metrics such as video resolution, frame rate, and buffering times, with an emphasis on minimizing delays and interruptions. Modern video streaming technologies may adapt to varying network conditions by dynamically adjusting video quality (e.g., reducing resolution and/or bitrate). Existing buffering techniques and adaptive streaming protocols may mitigate latency issues, ensuring smooth playback even under fluctuating network conditions. Every frame contributes equally to the viewing experience. Loss or corruption of even a small portion of the data (e.g., a few frames) may degrade the perceived quality, leading to interruptions or pixelation. Thus, packet loss and jitter are parameters that may significantly impact the quality of video delivery. The traffic generated by video streaming is generally asymmetric, with a higher volume of data flowing from the server to the client (downlink).

In contrast, emerging machine vision applications, such as cloud and edge-assisted object detection and tracking for autonomous vehicles, drones, and mobile robots, present distinct network demands. These applications generate substantial uplink traffic, including images and videos, which may be transmitted from machines to cloud and/or edge servers for processing. The processed information, though less voluminous, may then be sent back to the machines to enable follow-on actions. Real-time object detection and tracking require near-instantaneous data transmission and processing to enable timely decision-making and actions by mobile machines. The utility of data in machine vision applications is closely tied to its timeliness, as delayed data may render high-utility information obsolete, particularly in dynamic environments.

Certain machine vision data flows may have higher priority, such as data capturing an object in a vehicle's path, which is crucial for navigation and collision avoidance. The traffic patterns for machine vision applications may show high variability and bursts, driven by the episodic nature of sensing and control operations. In real-life scenarios, machine vision data may be event-driven, with data importance spiking during critical events, such as obstacle detection. Consequently, not all data generated by machines is equally important, as data related to significant environmental changes may have higher utility than static or redundant information. Efficient data prioritization and compression techniques may be particularly useful to ensure that the most relevant data is transmitted and processed first. Unlike video streaming, machine vision applications may have event-based data prioritization and/or stringent latency requirements, as these metrics may significantly impact the functionality and safety of machines, such as autonomous vehicles, drones, and/or robots.

To address these challenges, methods for offloading some of the burden and complexity of managing machine vision tasks from machine vision applications and devices to intelligent machine vision services in the network may be utilized. These services may provide benefits such as, for example, enabling simpler machine vision (MV) applications which require comparatively less development, deployment, and/or maintenance resources. Additional benefits may include an increased level of coordination between machine vision tasks and the communication and compute resources necessary for performing these tasks effectively.

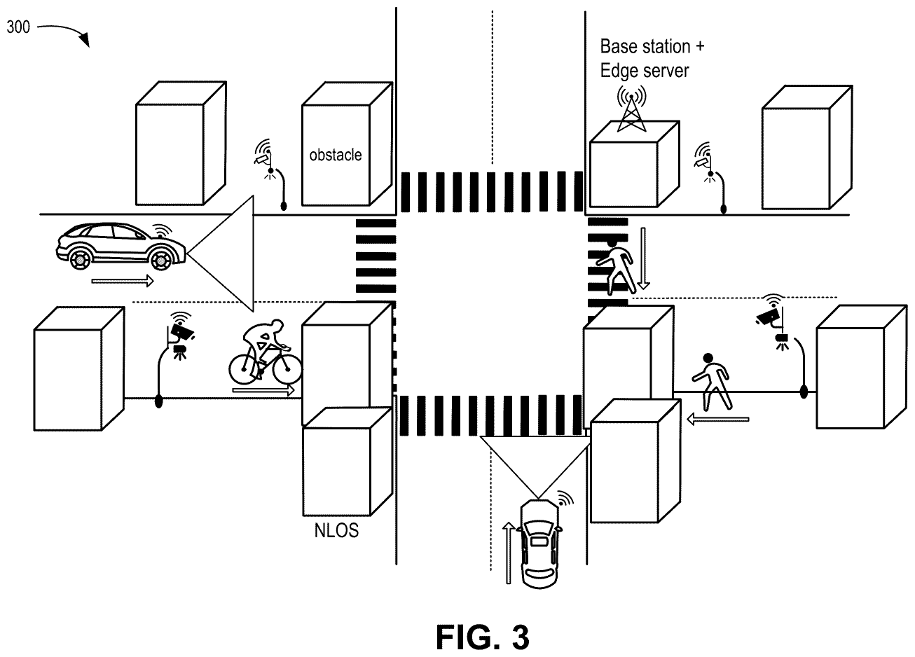

FIG. 3 is a diagram 300 illustrating an example of a machine vision (MV) smart intersection. In an example use case scenario, illustrated in FIG. 3, connected smart vehicles may navigate through a busy intersection having multiple blind spots and non-line-of-sight (NLOS) conditions. These vehicles may rely on assistance from machine vision-capable roadside cameras positioned throughout the intersection.

The burden and complexity of performing machine vision-centric tasks in scenarios such as the smart intersection example in FIG. 3 may be managed and/or performed by the application layer. Many machine vision tasks may include some application and/or user-defined aspects, such as an object of interest (e.g., pedestrian, bicyclist, and/or vehicle), an area of interest (e.g., around a corner), or a schedule and/or time frame of interest (e.g., within the next 10 seconds). Likewise, machine vision tasks may include levels of quality, accuracy, or precision which may depend on application and/or user-specific requirements, and which may vary over time (e.g., depending on a speed of a vehicle). Many machine vision tasks may require sensing operations to be performed in a distributed and coordinated fashion involving multiple entities. These entities may include, for example, vehicles, pedestrians, and cameras, as well as multiple networks and subnetworks, such as cloud, edge, and area networks. Each of these entities and networks involved may, at any one point in time, have some dynamicity as it relates to their availability and/or a number of resources the entities can allocate to performing the machine vision task. Collectively, these variables and attributes may make the management of machine vision tasks challenging and burdensome for machine vision applications to perform independently.

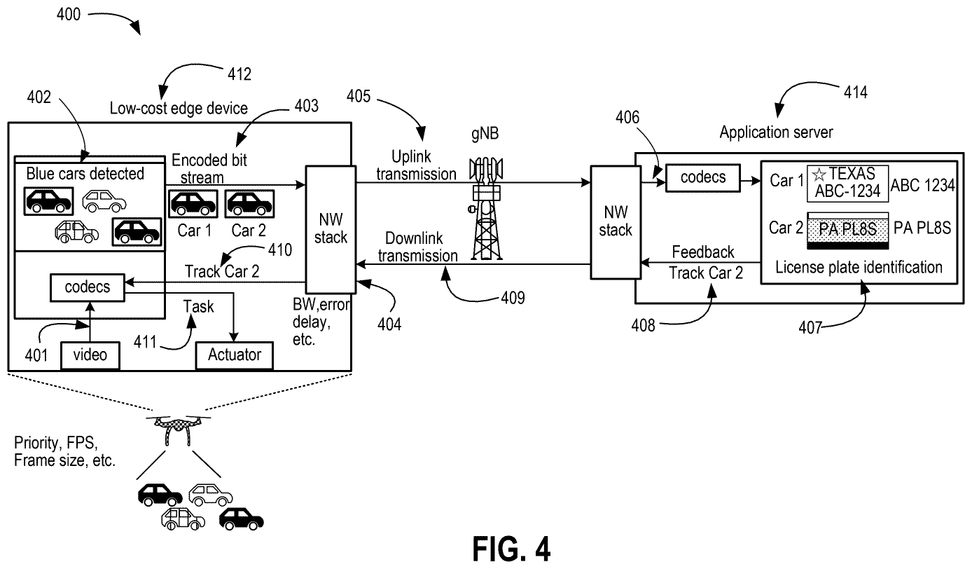

FIG. 4 is a diagram 400 illustrating an example of machine vision (MV) vehicle tracking. In the example use case scenario, shown in FIG. 4, machine vision-equipped devices (e.g., video cameras, LIDAR sensors, and/or other sensors) may be utilized to monitor a local area of interest to detect and/or track a vehicle matching a specified license plate number. Once the vehicle is detected the vehicle may be tracked. The machine vision-equipped devices, such as the low-cost edge device 412, may be assisted by edge and/or cloud servers to help carry out the security-sensitive and compute-intensive processes associated with smart surveillance (e.g., license plate identification at 407). A cellular network may be used to provide connectivity between the machine vision-equipped devices, edge servers, and/or the application server or cloud server 414.

The machine vision vehicle tracking process may be executed through a multi-step approach. At 401, machine vision-equipped devices may capture data (e.g., sensor input data from the WTRU) from their surroundings (e.g., video frames from an area surrounding the WTRU). This data may then be processed locally by the devices and/or by edge servers located near the devices. For example, local AI-based machine vision models on the devices may perform object detection and/or classification (e.g., detecting all blue vehicles at 402). If some object detection/classification thresholds are met (e.g., a high confidence threshold of blue cars detected), then the corresponding application data (e.g., video frames containing blue vehicles) may be encoded into bitstreams at 403. These encoded bitstreams may be packetized via the network (NW) stack 404 and may be transmitted as uplink packets via the gNodeB (gNB) in an uplink transmission 405.

At 406, the packets may be forwarded to the cloud application server 414 for additional processing, where application codecs may decode the data and perform follow-on actions, such as, AI-based machine vision processing at 407 (e.g., identifying a specific license plate as a follow-on action). Based on machine vision inference results (e.g., a high confidence level in identifying a license plate of interest), the application server 414 may generate appropriate machine vision commands for one or more follow-on actions (e.g., to track and follow a vehicle with the identified license plate of interest) at 408. These machine vision commands may be transmitted over the network to the machine vision-equipped devices in a downlink transmission 409. At 410, the machine vision commands may be extracted and executed by the machine vision-equipped devices, which may then perform the requested machine vision tasks (e.g., object tracking) at 411 to track the target vehicle. Examples of follow-on actions may include adjusting a navigation path of a vehicle, modifying a speed of a vehicle, detecting an object, classifying an object, and/or tracking an object. The follow-on actions may be performed based on data related to the machine-vision tasks, such as, for example, received input data, sensor input data from the WTRU and/or metadata associated with the received input data and/or the sensor input data from the WTRU.

End-to-End (E2E) latency may be affected by the performance of machine vision cloud and edge application servers, which may not be under network control. During the execution of a cloud and/or edge-assisted machine vision task, the application server compute resources may fluctuate, ranging from lightly loaded to heavily loaded states and even becoming entirely unavailable. Such variability may result in varying cloud or edge inference quality and timeliness, which in turn may impact the application round trip time and ultimately degrade the machine vision task performance (e.g., a missed opportunity to track and follow a vehicle of interest).

Machine vision application communication requirements may vary over time based on different application-specific machine vision tasks and situations. In the context of a cloud or edge-assisted smart surveillance use case, varying numbers of objects with diverse behaviors may be present in the area to be surveilled at different times. For example, vehicles may travel at different speeds, resulting in vehicles staying in a machine vision-equipped device's field of view for varying amounts of time. This variability may lead to different amounts of data being generated by the machine vision application, thereby generating and transmitting fluctuating amounts of data to the cloud or edge server. This type of event-based application task requirement may have a direct impact on the application round trip time latency and network bandwidth requirements, which may be highly dynamic and unpredictable.

In examples, the same machine vision application may have different quality of service (QoS) requirements based on different environmental conditions, such as driver behavior. In a cloud or edge-assisted machine vision scenario within a given area of interest, the objects of interest (e.g., vehicles) may have varying speeds and/or driving behaviors, ranging from cautious and safe to aggressive and unsafe. This variation in driver behavior may determine how long the objects of interest remain within the field of view of the machine vision-equipped devices. The data captured by the devices when the object of interest appears in the field of view may need to be transmitted to the cloud or edge server for inferencing, and the inference results may be returned to the devices before the object of interest leaves their field of view. The unpredictable user behavior may be utilized to determine the bandwidth and latency requirements of the application executing the machine vision task. Scenarios involving cautious or safe driving instances may require moderate latency and bandwidth requirements, while scenarios involving aggressive or unsafe driving instances may generate more critical bandwidth and latency requirements.

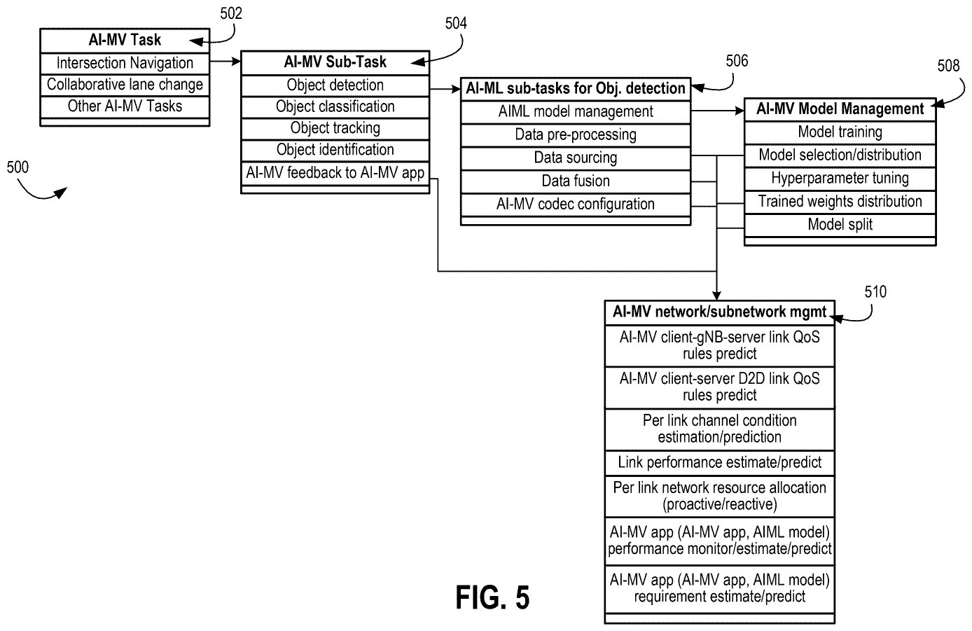

FIG. 5 is a diagram 500 illustrating an example organization of artificial intelligence-based machine vision (AI-MV) tasks, related sub-tasks and/or sub-processes that may influence AI-MV subnetwork management policy. The AI-MV tasks 502 may include, for example, intersection navigation, collaborative lane change, and/or other relevant machine-vision tasks. An AI-MV task may include multiple AI-MV sub-tasks. For example, an intersection navigation AI-MV task may include multiple AI-MV sub-tasks, including sub-tasks such as object detection, object classification, object tracking, object identification, and/or AI-MV feedback to an AI-MV client application. One or more of the sub-tasks 504 (e.g., object detection) may be performed by the execution of multiple AI machine learning (AI-ML) sub-tasks at 506.

The AI-ML sub-tasks for object detection 506 may include tasks and/or sub-processes such as AI/ML model management, data pre-processing, data sourcing, data fusion, and/or AI-MV codec configuration. AI-ML model management 508 may include additional sub-tasks such as model training, model selection and/or distribution, hyperparameter tuning, trained weights distribution, and/or model split.

To ensure proper execution of a complex AI-MV aided machine-task (e.g., intersection navigation), efficient orchestration of each of these sub-tasks and sub-processes may be managed across multiple devices. The AI-MV network/subnetwork management 510 may include managing the AI-MV client-gNB-server link quality of service (QoS) rules, AI-MV client-server device-to-device (D2D) link QoS rules, per link channel condition estimation and/or prediction, link performance estimation and/or prediction, and/or per link network resource allocation (e.g., proactive or reactive). At 510, the AI-MV network/subnetwork management may include AI-MV application performance monitoring, estimation, and/or prediction, as well as requirement estimation and/or prediction for the AI-MV application and/or AI-ML model.

An inference operation as a part of an AI-MV task may be performed in various inference modes, including locally on AI-MV clients (e.g., local inference), remotely on AI-MV servers or AI-MV clients (e.g., remote inference), and/or across a set of AI-MV clients or servers (e.g., split inference). An inference mode may be selected from the plurality of inference modes based on, for example, configuration information received for the plurality of inference modes, network conditions detected by the WTRU, and/or resource availability at the WTRU. The plurality of inference modes may include local, remote, and/or split inferencing modes. The configuration information may include, for example, network resource availability for executing the AI-MV task for ne or more of the plurality of inference modes and/or processing capabilities of the AI-MV clients and/or servers. In local inference mode, an AI-MV task may be run with an acceptable speed and/or accuracy locally on AI-MV clients. In such cases, a receiver expecting to receive AI-MV task inference results may not need to access to the sensed input. For example, a collision avoidance notification between a vehicle or roadside unit (RSU) and a pedestrian, the pedestrian may only need alerts associated with approaching direction in near-zero latency but may not need the visual appearance of cars.

In remote inference mode, the WTRU (e.g., device that captures the image and/or video content) may lack sufficient computational resources to perform complex AI models for the AI-MV task. However, the WTRU may be able to execute less complex AI-MV task (e.g., smaller model architecture and/or a pruned or quantized network) because of hardware limits, device costs and/or temporary compute capacity drop (e.g., heavy workload and/or battery usage), which may compromise on target accuracy. The WTRU may have at least one video codec that compresses and transmits the captured video content for remote inference of the AI-MV task. The WTRU may store the compressed video locally while receiving the inference result from a remote device. When compressing the captured video, the WTRU may utilize a simple AI model to optimize codec configuration for the target task. When the AI-MV task involves an inference task, the procedure of “MV task offload to AI-MV service” may be leveraged for configuring remote inference (e.g., transferring an MV task AI model from an AI-MV client to an AI-MV server).

In split inference mode, the AI-MV task may be split, and part of the computation may be executed at the WTRU and part on a network device. In this mode, the WTRU may infer a first part (e.g., head) of the model, while the second part (e.g., tail) of the model may be executed on a remote machine, such as a network edge or a nearby device. This mode may include transmission of intermediate data, also known as extracted features, which may need compression to meet bandwidth and latency constraints.

The challenges facing AI-MV inference tasks include issues of resource management, server coordination, and service contention. One issue may be that an AI-MV inference task may require many resources (e.g., computation and storage) to be provided by a single edge or cloud server. In turn, the AI-MV inference task may need to be split and executed by multiple edge or cloud servers, raising the challenge of determining and coordinating the appropriate servers and distributing the task among them effectively. Another issue may be that an AI-MV inference task may be composed of multiple basic AI-MV tasks and/or multiple AI-MV sub-task sequentially with each basic AI-MV task and/or each AI-MV sub-task requiring running a different AI model. Furthermore, each AI model, or each basic MV task, may be hosted by or require different edge/cloud servers. This may present the challenge of how to discover multiple edge/cloud servers, how to distribute AI models among those multiple edge/cloud servers, how to connect those multiple edge/cloud servers in a cascaded structure according to the requirements of the MV inference task, and/or how to coordinate the overall operations.

Some common terminology utilized herein may include the following. A machine vision application (MV app) may include applications such as a V2X driver assistance application. The MV app client refers to the component of an MV app that may initiate requests to an MV app server. An MV app client may receive responses, notifications, and/or commands from a server (e.g., MV app server). An MV app server may be a component of an MV app which receives and processes requests from MV app clients. An MV app server may send responses, notifications, and/or commands to MV app clients.

An AI-MV task may refer to an autonomous action performed by a machine (e.g., intersection navigation in autonomous vehicles and/or object detection, classification, and/or tracking by an autonomous drone in smart surveillance). These tasks may utilize AI-ML models that are either running locally on the machine, on a remote server, and/or a combination of both. The AI-ML models may be trained on a set of operations performed to accomplish an AI-MV app objective (e.g., object detection, object tracking, and/or collision detection and/or avoidance. The terms AI-MV task, MV task, MV inference task, and inference task may be used interchangeably herein. AI-MV tasks may involve one or more AI-ML operations (e.g., AI-MV sub-tasks). These AI-MV sub-tasks may include, for example, object detection, classification, tracking, identification, and/or providing AI-MV feedback to the AI-MV client application. Each AI-MV sub-task (e.g., object detection) may require the proper execution of multiple AI-ML sub tasks (e.g., AIML model management, AIML model input data pre-processing, AIML model input data sourcing, AIML model data fusion, and/or AI-MV codec configuration).

An MV service may include a service capable of offloading and assisting MV apps with managing MV sub-networks and performing MV tasks on behalf of the applications. An MV service may include one or more MV clients and one or more MV servers.

An MV client may be a component of an MV service. An MV client within an MV service may initiate requests to an MV server and may receive responses, notifications, and/or commands from the MV server. An MV server may also be a component of the MV service, and may receive and/or process requests from MV clients. An MV server may send responses, notifications, and/or commands to MV clients.

An AI-MV service represents an MV service equipped with AI capabilities to learn and perform intelligent MV operations. Within an AI-MV service, an AI, as a type of MV client may function as a specialized MV client that initiates requests to an AI-MV server, receiving responses, notifications, and/or commands from an AI-MV server. The terms AI-MV client and MV client may be used interchangeably. The AI-MV server may be a component of the AI-MV service. The AI-MV server may function as a specialized MV server, which may receive and/or process requests from AI-MV clients, and/or send responses, notifications, and/or commands to AI-MV clients. The terms AI-MV server and MV server may be used interchangeably herein

The MV task AI model refers to AI model(s) used during the operations of an MV task. In some examples, the AI model may be in the form of deep neural networks (DNNs), convolutional neural networks (CNNs), and/or a transformer. For example, an image classification MV task may have CNN-based AI model, which takes images as input and generates a label indicating the image category. A basic MV task may involve only a single MV task AI model.

The MV Task Originator (MVTO) describes the entity initiating an MV task, which may include an MV app client or MV app server, while the MV Task Execution Entity (MVTEE) represents the entity where the MV task is executed.

The methods and systems described herein may be based on certain principles and observations. For example, signaling overhead for a WTRU to request remote or split inference for MV tasks from edge or cloud servers may be controlled and maintained as low as possible. MV tasks composed of multiple basic MV tasks may be considered. Different types of MV tasks may have different authorization and authentication requirements. As such, authorization and authentication of different MV tasks may be customized. These methods and systems may be generic such that they may apply to a broad set of MV tasks, remaining adaptable rather than being limited to a specific type of MV tasks.

The methods and systems described herein may provide various benefits, which may include, for example, an ability for an AI-MV service to offer more advanced, intelligent MV services required by machine vision use cases such as collaborative and/or remote driving. For MV inference tasks, the methods and systems described herein may offer several additional benefits. For example, when an MV inference task cannot be served by a single edge or cloud server, the adaptive and automatic allocation of the MV task or MV sub tasks across multiple edge or cloud servers may support the task with the required MV task precision. For MV inference tasks comprising multiple basic MV tasks and/or multiple MV sub-tasks), processing may occur on one or more edge or cloud servers arranged in a chain structure. To further reduce signaling overhead between the WTRU and edge or cloud server, pre-configured policies at the server and/or explicit indications WTRU from the WTRU may be leveraged. Additionally, or alternatively, MV inference task requests sent from the WTRU to the edge or cloud server may be authorized and authenticated in a task-aware approach.

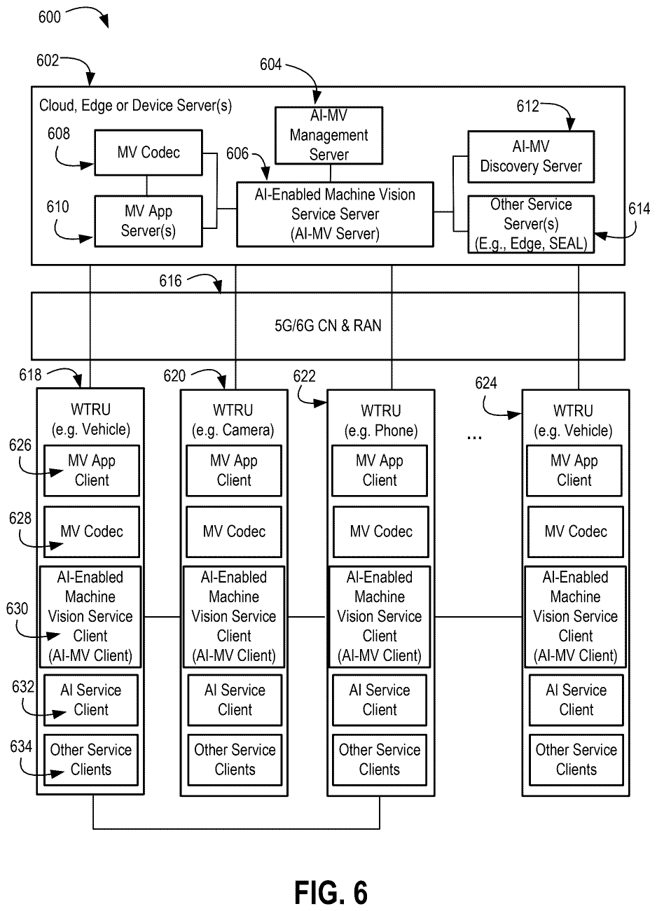

FIG. 6 is a diagram 600 illustrating an example of an AI-enabled machine vision (AI-MV) service architecture. The AI-MV service architecture shown in FIG. 6 may be a system-level embodiment comprising an AI-MV service. The service architecture may comprise one or more AI-MV servers (e.g., a plurality of AI-MV servers), which may be hosted in the cloud, at the edge, and/or on a device 602. The AI-MV service architecture may also comprise one or more AI-MV clients hosted on a WTRU 618, 620, 622, and/or 624 (e.g., vehicles 618, 624, cameras 620, and/or phones 622). In examples, an AI-MV server may be hosted on a WTRU, though this configuration is not illustrated in FIG. 6. AI-MV clients and/or AI-MV servers may perform MV task-aware adaptive inferencing.

One or more cloud, edge, and/or device servers 602 may host various components of an AI-MV service, including, for example, one or more (e.g., a plurality of) AI-MV management servers 604, AI-MV servers 606, MV Codecs 608, MV application servers 610, AI-MV discovery servers 616, and/or other service servers 614 (e.g., 3GPP edge enabler server, 3GPP service enabler architecture layer (SEAL) server/services).

A 5G/6G CN and RAN 616, may be utilized to enable communication between the cloud, edge, and/or device servers and/or one or more WTRUs 618, 620, 622, and 624, which may be AI-MV clients. At 618, an example WTRU configured as a vehicle is shown, which may include several AI-MV client components. The WTRU may include an MV application client 626, an MV codec 628, an AI-MV Client 630, an AI service client 632 and/or other service clients 634 (e.g., SEAL clients and/or edge enabler clients).

It may be assumed that the execution of an AI-MV task may include one or more sub tasks that rely on AI-ML inference operations. Examples of inference operations may include semantic segmentation, saliency estimation, surface normal estimation, human part segmentation, edge estimation, and/or depth estimation. To fulfill an MV task, multiple inference operations may be aggregated together. The entity that originates the AI-MV task may be referred to as the MV Task Originator (MVTO) or MV Task Source (e.g., an MV app client, and/or an MV app server). The entity where the MV task is performed is referred to as the MV Task Execution Entity (MVTEE).

An inference operation may include one or multiple forward passes of an MV task AI model, using MV data as input and/or generating an MV inference result and/or inferred MV knowledge as output. The MV data may be collected and/or provided by an MVTO, while the MV inference result may be stored at and/or shared with entities such as the MVTO, MVTEE, MV app server, and/or MV app client. The MV inference result, if it is correct, may be used as a label, together with the MV data, to form new training data which may be used for training of new MV task AI models and/or the retraining of existing MV task AI models.

Inference modes (e.g., local inference, remote inference, split inference, and/or other types of inference) may be dynamically determined by entities (e.g., MVTO, MVTEE, MV app client, and/or MV app server to improve MV inference performance. This dynamic approach may be referred to as adaptive inference.

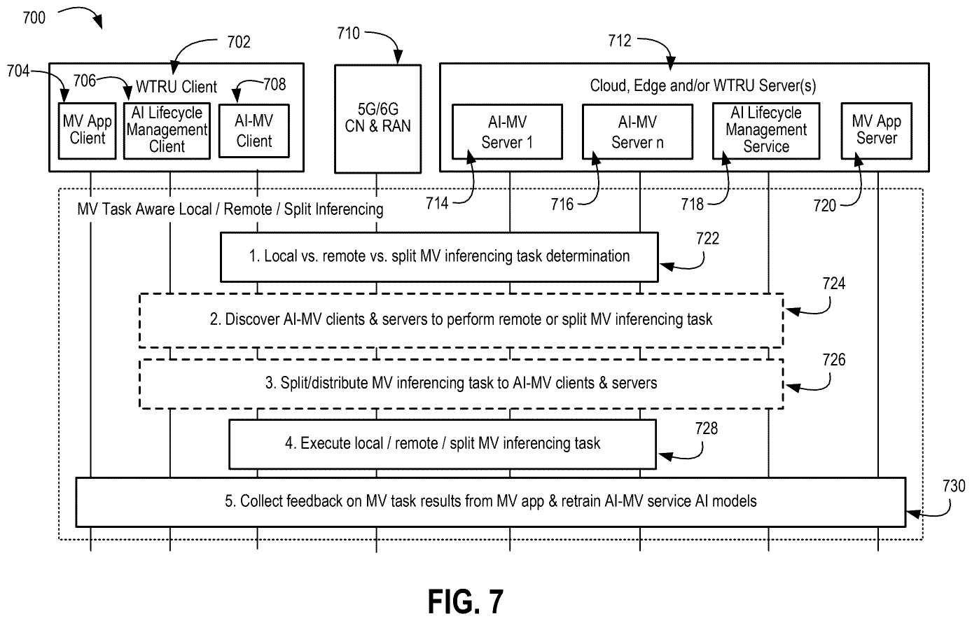

FIG. 7 is a diagram 700 illustrating an example method for MV task-aware adaptive inference (e.g., local, remote, and/or split inference) performed by an AI-MV service. For example, during the execution of an MV task, the AI-MV service may determine whether to perform local, remote, and/or split inference across one or more WTRU clients 702 and/or cloud, edge, and/or WTRU servers 712. This process may include offloading inference operations to AI-MV clients and/or AI-MV servers and may provide several advantages, including, for example, alleviating inference overhead such as computation and/or energy consumption at MV app clients. Using an AI-MV service to coordinate the inference operations to be performed at AI-MV servers may simplify the operations at MV app clients. For example, the MV app client may not need to discover AI-MV servers and/or coordinate full-offloading and/or adaptive split decisions with the AI-MV servers. Further, discovering suitable AI-MV servers may be made more efficient for the AI-MV service. The AI-MV service may also provide more secure communications with the AI-MV server and/or may have more capability to authenticate AI-MV servers, which may enable selection of more secure and trustable AI-MV servers.

At 702, a WTRU client may include various components, such as an MV app client 704, an AI Lifecycle Management client 706, and/or an AI-MV client 708. These components may be connected via a 5G/6G CN and RAN 710 to cloud, edge, and/or WTRU servers 712.

The cloud, edge and/or WTRU servers 712 may include multiple AI-MV servers, including, for example, AI-MV Server 1 at 714, AI-MV Server n at 716, an AI Lifecycle Management Service 718, and/or an MV App Server 720.

At 722, a local vs. remote vs. split MV inferencing task determination may be initiated by the AI-MV service to decide the optimal inference mode. This determination may be based on various factors, such as MV task requirements, resource availability, and network conditions.

In adaptive inference, AI-MV clients and/or servers may use MV task AI models to make MV inference-based determinations (e.g., detect, classify and/or track an object) as part of an MV task.

In examples, various triggers may initiate task performance. For example, during the execution of an MV task, an AI-MV client may request assistance from one or more AI-MV servers regarding inference operations of an AI-MV task that is executed on behalf of an MV app client, and may be co-located with the AI-MV client). An AI-MV client may perform full task offloading (e.g., remote inferencing) to one or multiple AI-MV servers. The AI-MV server may request assistance from other available AI-MV servers regarding inference operations of an AI-MV task that is executed by an AI-MV client. The information elements that are transmitted as part of the AI-MV task and/or sub-task inference assistance request are shown in further detail herein below in Table 1.

An AI-MV server may proactively notify an AI-MV client, that is executing an AI-MV task, regarding available AI-MV servers to aid in inference operations related to the AI-MV task. The AI-MV client or server may also determine whether to perform the MV task by inferencing locally, remotely on another AI-MV client or server, and/or split across multiple (e.g., a set of) AI-MV clients or servers.

TABLE 1
AI-MV task/sub-task inference assistance request

| Information Element | Description |
|---|---|
| AI-MV client/server ID | An identifier for the AI-MV client/server |
| AI-MV Task ID | An identifier for a MV task associated with an AI-MV client/server |
| AI-MV task priority | An identifier for the priority of the AI-MV task |
| AI-MV sub-task ID(s) | Identifier(s) for AI-MV sub-task(s) belonging to an AI-MV task ID |
| AI-MV client app ID | An identifier for the AI-MV app client |
| AIML model information | Active AIML model ID, available AIML model IDs, model weights, utilized |
| | compute resources, required model precision, observed model precision, |
| | data pre-processing requirement, inference latency, etc. |
| AI-MV client/server information | Context information about AI-MV client/server such as but not limited to |
| | available compute resources, available energy resources, observed energy |
| | consumption, available codecs, compute latency, estimated network |
| | conditions, etc. |

Based on the AI-MV task and/or sub-task inference assistance request from an AI-MV client, and/or based on the AI-MV task and/or sub-task inference assistance response from the AI-MV client (e.g., after an AI-MV server proactively offers inference assistance to the AI-MV client), the AI-MV server may determine a most optimal inferencing method (e.g., local, remote, and/or split inference).

A local vs. remote vs. split task inference determination may be made by an AI-MV client and/or server and may be based on one or multiple inference deciding factors, such as, for example, MV task execution requirements and/or the availability of resources on AI-MV clients and/or servers (e.g., video, CPU, graphics, memory, battery level, codec, and/or communication resources).

A determination may be made by an AI-MV client and/or server to perform local, remote, and/or split task and inference operations. The determination may be based on one or more inference deciding factors. These factors may include MV task execution requirements and/or the availability of resources (e.g., video, CPU, graphics, memory, battery level, codec, and/or communication resources) among available AI-MV clients and/or servers. The determination may further be based on the priority of the AI-MV task and/or sub-task, network congestion patterns detected by an AI-MV client and/or server, and/or network measurements such as end-to-end (E2E) latency, jitter, and/or reliability. The determination may be based on MV task result accuracy patterns such as the degree of accuracy achieved by application tasks, the level of confidence on the produced prediction for a given model, and/or input content. The determination may be based on the available codecs at the WTRU and/or within the network, along with their inherent performances. Codec performance criteria may include factors such as image or video codecs or codecs used for intermediate tasks. For example, criteria such as bit-rate accuracy trade-offs (e.g., how much the task accuracy may drop depending on a target bitrate) and/or encoder/decoder complexity (e.g., a number of operations that may be measured in MACs per pixel, peak memory consumption, and/or throughput) may impact decisions on distribution of compute and/or data transfer operations.

An AI-MV client or server may be equipped with one or more AI-MV service AI models, which may consider the above metrics to make intelligent determinations regarding whether to perform local, remote, and/or split task and inference operations. Using these AI-MV service AI models, an AI-MV client or server may learn to identify the most optimal situations in which to perform local, remote, and/or split task and inference operations. This learning may involve training the AI-MV service AI models using data, which may include offloaded MV task attributes (e.g., MV task type), MV task results, accuracy and/or precision levels of MV task results, and/or measurements of compute and/or communication resources needed by the AI-MV client or server to execute MV tasks. This training may enable the AI-MV service AI models to learn the most optimal situations in which MV tasks and/or inferencing should be run locally, remotely, and/or in a split manner, ensuring that MV task results and AI-MV client and server compute and communication resources are optimized. Once the AI-MV service AI models have been trained, the AI-MV client and/or server may then use the AI-MV service AI model(s) to make intelligent and informed determinations on whether to perform inferencing locally, remotely, and/or in a split manner.

At 724, when an AI-MV client or server determines to perform remote and/or split inference, AI-MV service discovery operations may identify candidate AI-MV clients and/or servers to perform the remote or split inference operations. This discovery process may be optional when candidate AI-MV clients and/or servers have been previously identified, pre-configured, and/or selected, and are still valid (e.g., most optimal). However, if previously identified AI-MV clients and/or servers are determined to no longer be the most optimal, the AI-MV service discovery operations may be performed to re-identify new candidate AI-MV clients and/or servers.

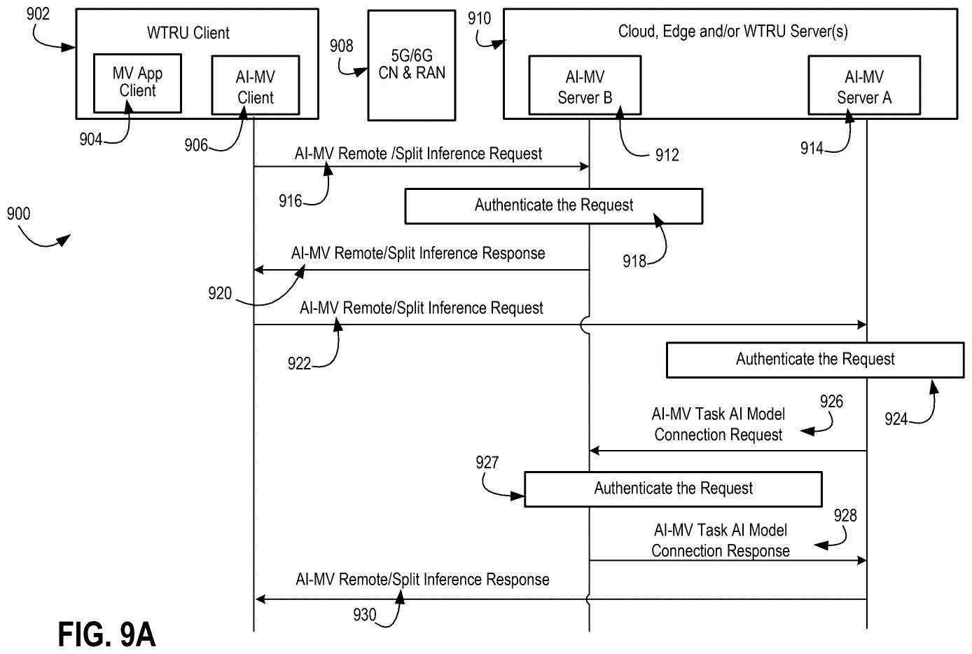

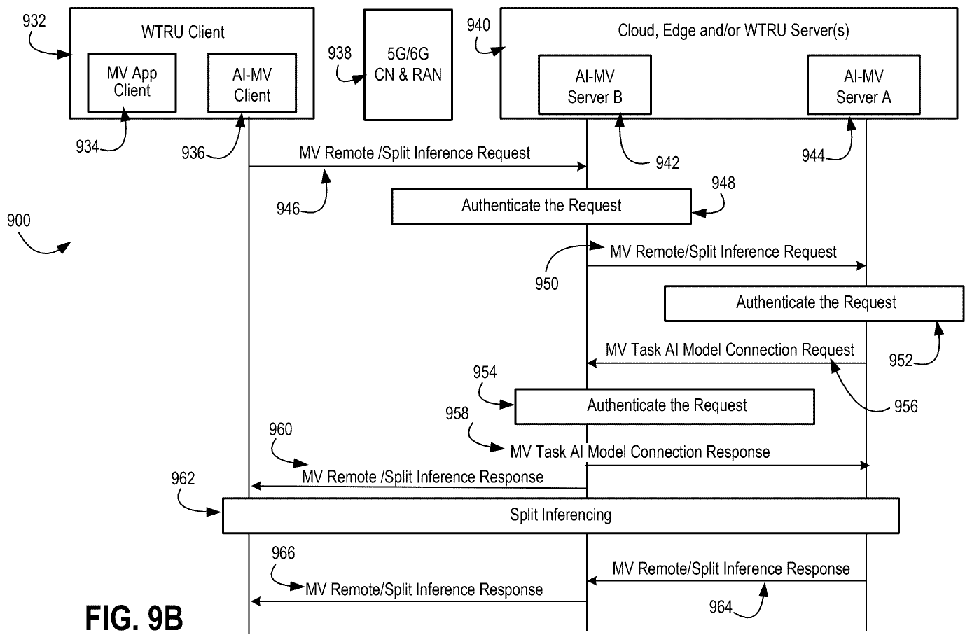

At 726, the MV inference task may be split and/or distributed to one or more AI-MV clients and/or servers for processing. At 728, the AI-MV clients and servers may execute the MV inferencing task according to the determined inferencing type. For example, in split inferencing mode, part of the computation may be handled by the WTRU client 702 and part of the computation may be handled by the AI-MV servers 714 and/or 716. After executing the MV inferencing task, feedback may be collected on MV task results at 730, which may be used to update and retrain AI-MV service AI models. Examples of 726 are given in FIG. 9A and FIG. 9B.

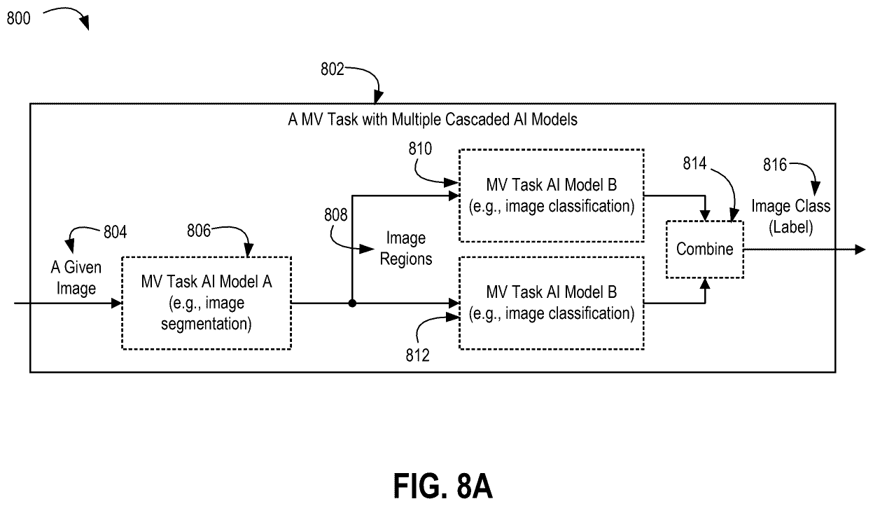

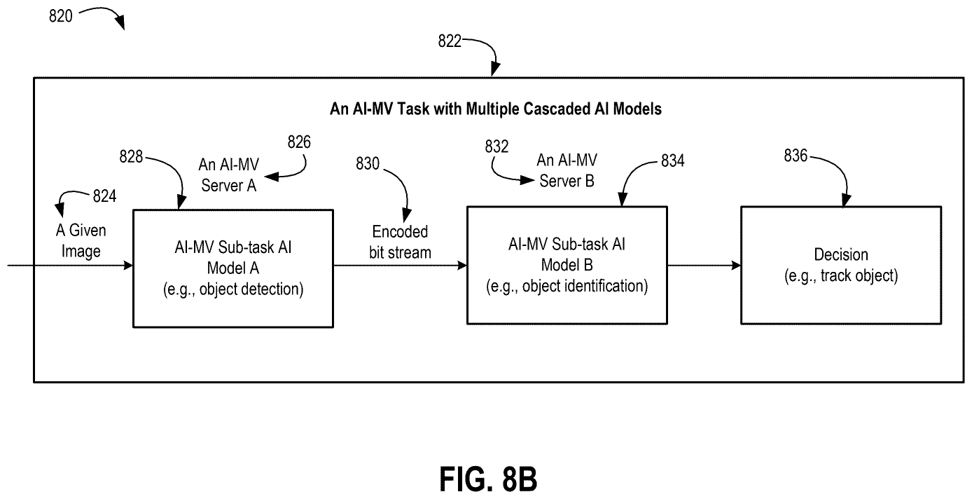

FIG. 8A is a diagram 800 illustrating an example MV task with multiple cascaded AI models 802, which may execute sequentially. FIG. 8A illustrates an example in which MV sub-tasks may include two AI models: MV task AI model A 806 for image segmentation and MV task AI Model B 810, 812 for image classification. At 804, a given image may be received as input. This image may be processed by MV Task AI Model A 806 (e.g., image segmentation) to generate segmented image regions 808. The segmented image regions 808 may serve as input to MV Task AI Model B 810, 812, and a sub-task may take a given image, which may include multiple objects, as input and may output separate image classification regions for the different objects, respectively, to MV Task AI Model B 810, 812. The output from each instance of MV Task AI Model B 810, 812 may represent different image classes and/or labels (e.g. one for each object) that may be combined at 814 to produce a final image class label 816 as an output vector.

In scenarios in which there may be instances where no single AI-MV server has sufficient resources to support comparatively large AI models to complete an MV task, a comparatively large MV task AI model may be split and offloaded to different AI-MV servers. In examples, an AI model for image segmentation (e.g., AI Model A 806) may be more complex and/or larger than an AI model for image classification (e.g., AI Model B 810 and 812). As a result, an AI-MV server may be able to perform image classification with multiple AI models (e.g., model B 810, 812). In scenarios where available AI-MV servers are experiencing overload conditions or have compute limitations, then through adaptive inferencing the AI-MV sub-tasks for a particular AI-MV task can be executed across multiple AI-MV servers.

FIG. 8B is a diagram 820 illustrating an example of an AI-MV task 822 (e.g., smart surveillance) that may comprise multiple AI-MV sub-tasks (e.g., object detection and/or object identification). The AI-MV sub-tasks may involve AI-ML inferencing that are executed on different servers (e.g., AI-MV server A and AI-MV server B) in a concurrent manner. At 824, a given image may be received as input data (e.g., video frames from an edge device such as a camera-equipped drone), which may be offloaded to an AI-MV server A, which may then perform an AI-MV sub-task AI Model A (e.g., object detection) at 828 on the input data.

If an object is detected, AI-MV server A 826 may encode the result into a bitstream 830 and may forward the encoded bit stream to AI-MV server B 832. AI-MV server B 832, which may then perform a follow-on AI-MV sub-task (e.g., AI-MV sub-task AI Model B) at 834, such as object identification. If an object is positively identified, then follow-on actions may be performed, including, for example, a decision to track the identified object being made at 836.

This manner of adaptive inferencing may optimize the utilization of compute resources across multiple available AI-MV servers for a given AI-MV task 822 and/or may optimize the network bandwidth utilization between AI-MV servers. For example, an AI-MV server A 826 may transmit data to the next AI-MV server B 832 only after positive inference results are detected, enabling scalability.

In examples, processes for determining local, remote, and/or split inference, as well as for identifying candidate servers for these tasks, may also be jointly performed. For example, if a determination is made to perform remote inference, and a proper AI-MV candidate server is not able to be identified for remote inference, the determination process may be re-executed to perform an additional inference determination. It is to be appreciated that the order of these steps may be swapped (e.g., candidate AI-MV clients or servers may be identified first), based on which a determination on local, remote, or split inference may be made.

Once the determination regarding local, remote, or split inference for the MV task has been made, the corresponding MV task AI model(s) may be distributed or split as needed and the AI-MV clients and/or servers may perform the local, remote, and/or split inference operations for the MV task, described in further detail herein below with reference to FIG. 9A.

FIG. 9A is a diagram 900 illustrating an example of MV task AI model distribution for remote split inference. Components may include a WTRU client 902, which may comprise an MV App Client 904 and an AI-MV Client 906. These clients may connect via a 5G/6G CN and RAN 908 to a cloud, edge and/or WTRU server system 910. Within this server system, there may be multiple AI-MV servers (e.g., AI-MV Server B 912 and/or AI-MV Server A 914). When the remote and/or split inference configuration uses one MV task AI model, only certain steps (e.g., AI-MV remote/split inference request 916, authenticating the request 918, and/or AI-MV remote/split inference response 920) may be necessary to perform. However, if multiple MV task AI models may be necessary, as shown in FIGS. 8A and 8B, additional steps (e.g., AI-MV remote split inference request 922, authenticating the request 924, AI-MV task AI Model connection request 926, authenticating the request 927, AI-MV task AI Model connection response 928, and/or AI-MV remote split inference response 930) may also be necessary to perform. In this example, AI-MV server B may host MV task AI model B, and AI-MV server A may host MV task AI model A (e.g., similarly to the example in FIG. 8B). The output of MV task AI model A may be fed as input to MV task AI model B.

In examples, for single-model MV task distribution, the process may begin as follows. At 916, the AI-MV Client 906 may send an MV remote and/or split inference request to AI-MV Server B 912. This request may be used to distribute a complete and/or partial MV task AI model to AI-MV Server B 912. This request may comprise information elements, including, for example, those defined in Table 2 and Table 4.

TABLE 2
MV Remote/Split Inference Request

| Information Element | Description |
|---|---|
| Requestor identifier | An identifier for the requestor (e.g., AI-MV client) of this request. |
| Inference Mode | The mode of requested inference (e.g., remote inference with one AI model, remote inference |
| | with multiple cascaded AI models, split inference with one AI model, split inference with |
| | multiple cascaded AI models). |
| MV task ID | The identifier of MV task that 916 requests for. |
| MV task AI model | A complete (for remote inference) or a partial (for split inference) MV task AI model. |
| >Model ID | The identifier of the MV task AI model (a complete one and/or a partial one). |
| >MV task types | The type of MV task that this MV task AI model is applicable for. |
| >Model content | The content of this MV task AI model. |
| >Model address | The address from which this MV task AI model can be downloaded from. Only one |
| | of “Model content” and “Model address” may be needed. |
| >Address for model input | If the AI model is split and the current model is receiving inputs from another prior |
| | model, the address of the prior model output is specified here. |
| >Address for model output | The address where the model output needs to be sent. |
| | In 916, this address may be set to the contact address of AI-MV client or MV app. |
| | In 922, this address may be set to the contact address of AI-MV server B, which |
| | may have been included in 920. |
| Location | The location of the requestor. This parameter may also indicate the trajectory of the |
| | UE (e.g., a vehicle) that hosts the requestor. |
| AI-MV server A ID | The identifier of AI-MV server A. |
| Access token request | Indicate the need for AI-MV server B to generate or assign an access token according |
| | to “Access token generation methods”, which AI-MV server A can present this access |
| | token in 926 to establish the connection with AI-MV server B. The identifier of AI-MV |
| | server A may be considered by AI-MV server B to generate the access token, which is |
| | unique can only be used by AI-MV server A. |
| Access token generation | The methods of generating an access token (e.g., an access token template, an |
| methods | access token type such as OAuth 2.0 access token, etc.) |
| MV task security | The security credential of the requestor. |
| credential | |
| >MV task types | The types of MV tasks that this MV task security credential is applicable for. |
| >Usage scope | Indicate the usage scope of this credential (e.g., for requesting remote inference |
| | with one AI model, for requesting remote inference with multiple cascaded AI |
| | models, for requesting split inference with one AI model, for requesting split |
| | inference with multiple cascaded AI models). |

At 918, AI-MV Server B 912 may receive the request and may use “MV task security credential” to authenticate the request. If the request includes an indication requesting remote and/or split inference with multiple MV task AI models, AI-MV Server B 912 may determine whether to participate and be a part of cascaded AI models and/or whether it agrees to receive output from AI-MV Server A 914 as the input. If AI-MV server B agrees to participate and to be a part of cascaded AI models, it may generate an access token for AI-MV Server A 914. AI-MV server B may store the generated access token along with the associated “AI-MV server A ID” locally. The AI-MV server B may store the “MV task AI model” locally and/or retrieve it from the “Model address”.

At 920, AI-MV Server B 912 may generate and send an MV remote/split inference response to the AI-MV client. This response may comprise information elements such as, for example, those defined in Table 3.

TABLE 3
MV Remote/Split Inference Response

| Information Element | Description |
|---|---|
| Sender identifier | An identifier for the sender (e.g., AI-MV server B, AI MV server A) of this response. |
| MV task ID | The identifier of MV task being requested for remote/split inference. |
| Status | Indicate if the authentication in 918 (or 924) is successful and if the sender agrees |
| | to the requested inference. |
| Contact address | The contact address of the sender (e.g., AI-MV server B) for the sender to receive the |
| | output of another MV task AI model as the input data for the sender to perform inference. |
| Access token | The access token that is generated for and may only be used by AI-MV server A. |

In examples, the AI-MV client receives the response from 920. It may extract the contact address (e.g., of AI-MV server B) and/or the access token (e.g., for AI-MV server A). The AI-MV client may then send an additional MV remote/split inference request to AI-MV server A. This request may comprise information elements such as those defined in Table 2. This request may set the “Address for model output” to the “Contact address (e.g., of AI-MV server B) as received from AI-MV server B's response 920. Furthermore, this request may also comprise an access token (e.g., for AI-MV server A as received from 920). The request may further comprise the information about AI-MV task AI model B, which was previously distributed to AI-MV server B. Additionally, and/or alternatively (not shown in the figure), AI-MV server B may issue this request directly to AI-MV server A instead of the AI-MV client; in this case, the information about MV task AI model A may be contained in 916 and in turn AI-MV Server B can forward such information about model A to AI-MV Server A.

Upon receiving the request from the AI-MV client, the AI-MV Server A 914 may extract the contact address (e.g., of AI-MV server B) and/or the access token (e.g., for AI-MV server A) and the AI-MV server A may authenticate the request at 924.

At 926, the AI-MV Server A 914 may send an MV task AI model connection request to AI-MV Server B. This request may be used to connect MV task AI model A on AI-MV server A to, or with MV task AI model B on AI-MV server B, facilitating the flow of MV task AI model A's output as input to MV task AI model B. This model connection request may comprise information elements such as, for example, those defined in Table 4.

TABLE 4
MV Task AI Model Connection Request

| Information Element | Description |
|---|---|
| Requestor identifier | An identifier for the requestor (e.g., AI-MV server A) of this request. |
| Access token | The access token that is received from 920. This access token may be generated |
| | in 918 by AI-MV server B. |
| Contact address | The contact address of the requestor (e.g., AI-MV server A). AI-MV server B may |
| | send inference-related feedback or requests to AI-MV server A via this address. |
| MV task AI model A | Information about MV task AI model A being distributed to AI-MV server A via 922. |
| >Model ID | The identifier of the MV task AI model A. |
| >MV task types | The type of MV task that this MV task AI model A is applicable for. |
| >Model content | The content of MV task AI model A. |
| >Model address | The address from which MV task AI model A can be downloaded from. Only one |
| | of “Model content” and “Model address” may be needed. |
| >Output specifications | Specifications of the output of MV task AI model A. |

At 927, upon receiving the connection request at AI-MV Server B, AI-MV Server B may authenticate the request according to the access token associated with AI-MV Server A 914. If the Access token is valid for AI-MV Server A 914, AI-MV Server B 912 may agree to connect its MV task AI model B with MV task AI model A on AI-MV Server A 914 (e.g., take the output of model A as the input to model B). At 928, AI-MV Server B 912 may then generate and/or send an MV task AI model connection response to AI-MV Server A 914. This response may comprise the identifier of AI-MV Server B, the status of authentication (e.g., successful or failed), and/or a new contact address of AI-MV server B for receiving the output of MV task AI model A from AI-MV Server A 914.

At 930, AI-MV Server A 914 may then send an MV remote/split inference response to the AI-MV Client 906. This response may comprise information elements such as those defined in Table 3. This response may also comprise the authentication status. Following this, the AI-MV Client 906 may start to send input data (e.g., images) to AI-MV Server A 914 to execute corresponding inference operations. The AI-MV Server A 914 may then feed the input data to the locally hosted MV task AI model A to generate an output (e.g., intermediary inference result) which may be sent to AI-MV Server B 912. The AI-MV Server B 912 may take this intermediary inference result from AI-MV server A as input to its locally hosted MV task AI model B to generate the final inference result, which it may then send to the AI-MV Client 906 and/or other designated entities.

FIG. 9B is a diagram 900 illustrating an example of AI-MV task split inferencing across an AI-MV client and multiple AI-MV servers. In this example, the WTRU Client 932 may include an MV App Client 934 and/or an AI-MV Client 936. The WTRU Client 932 may connect to cloud, edge and/or WTRU servers 940 through the 5G/6G CN and RAN 938. The cloud, edge and/or WTRU servers 940 may include AI-MV Server B 942 and/or AI-MV Server A 944.

At 946, similarly to 916 and/or 922 in FIG. 9A, the AI-MV Client 936 on the WTRU Client 932 may send an MV Remote/Split Inference Request to AI-MV Server B 942. Upon receiving this request, AI-MV Server B 942 may authenticate the request at 948. Following authentication, AI-MV Server B 942 may send a further MV Remote/Split Inference Request to AI-MV Server A 944 at 950, similarly to 916 and/or 922 in FIG. 9A, requesting it to handle a portion of the inference task. AI-MV Server A 944 may then authenticate this request at 952.

Once authenticated, AI-MV Server A 944 may send an MV Task AI Model Connection Request to AI-MV Server B 942 at 954, indicating that it is ready to connect for the joint processing of the AI-MV task. Upon receiving this connection request, AI-MV Server B 942 may authenticate the connection request at 956, similarly to 926 in FIG. 9A. After completing the authentication process, an MV Task AI Model Connection Response 958, similarly to 928 in FIG. 9A, may be sent from AI-MV Server B to AI-MV Server A. Then, AI-MV Server B may send MV remote/split inference response 960, similarly to 930 and/or 920 in FIG. 9A to AI-MV Client 936.

The split inference task 962 may proceed, with AI-MV Client 936, AI-MV Server A 944, and AI-MV Server B 942 performing their respective portions of the AI-MV task. AI-MV Server A 944 processes its designated inference segment and, upon completion, may send intermediate results back to AI-MV Server B 942 at 964. AI-MV Server B 942 may update the AI-MV Client 936 on the WTRU Client 932 by sending a final MV Remote/Split Inference Response to the AI-MV Client 936 on the WTRU Client 932 at 966, concluding the AI-MV task. In scenarios where an AI-MV server receives a request to execute an AI-MV task or AI-MV sub-tasks of equal or higher priority, the AI-MV server may choose to split the inferencing of an ongoing AI-MV task of equal or lesser priority among other available AI-MV servers. This process may include the AI-MV server B first executing the remote or split inferencing procedure for an AI-MV client. The AI-MV server B then requests AI-MV server A to split or offload the inferencing task of the AI-MV client. After receiving the AI-MV server A acknowledgement to this request, the AI-MV server B optimizes the allocation of compute and communication resources between the AI-MV client, AI-MV server B, and AI-MV server A for joint execution of the split inferencing of the AI-MV task.

In scenarios where an AI-MV server receives a request to execute an AI-MV task or AI-MV sub-tasks of equal or higher priority, the AI-MV server may choose to split the inferencing of an ongoing AI-MV task of equal or lesser priority among other available AI-MV servers. This process may include the AI-MV server B first executing the remote or split inferencing procedure for an AI-MV client. The AI-MV server B then requests AI-MV server A to split or offload the inferencing task of the AI-MV client. After receiving the AI-MV server A acknowledgement to this request, the AI-MV server B optimizes the allocation of compute and communication resources between the AI-MV client, AI-MV server B, and AI-MV server A for joint execution of the split inferencing of the AI-MV task.

The AI-MV inference task may then be executed by the AI-MV clients and/or servers in a local, remote, or split fashion based on the previous determination. Through these inference operations, MV task results may be calculated which meet the MV task execution requirements. Likewise, these inference operations and MV task result calculations may be performed without exceeding the available compute and communication resources of the AI-MV clients and/or servers. The MV inference results are collected and aggregated by the AI-MV clients and/or servers as needed, and an MV task result is computed. During this process, AI-MV clients or servers performing the inference task may decide to change the current inference mode (e.g., from remote inference back to local or split inference) based on several factors, such as the arrival of higher-priority remote inference tasks from other AI-MV app clients, the availability of compute resources in the AI-MV clients or servers, the association or de-association of AI-MV clients or servers from the network, or the inference precision of the currently active AI-ML model(s) in the currently executed inference mode.

The AI-MV clients and/or servers may share the AI-MV task result with the AI-MV app clients and/or servers. The AI-MV clients and/or servers may then receive feedback from the AI-MV app client on whether the AI-MV task results meet the accuracy, precision, and latency requirements defined by the AI-MV app client. Based on this feedback, the AI-MV clients and/or servers may determine to reconfigure and/or redistribute the AI-MV task's AI models and/or inference operations across the AI-MV clients and/or servers. This may ensure that AI-MV task execution requirements are met, and that compute and communication resource utilization of the AI-MV clients and servers is accordingly the most optimal. The AI-MV app feedback may also be used by the AI-MV clients and/or servers to train the AI-MV service AI models to learn the most optimal situations in which to perform local, remote, or split AI-MV tasks and inferences.

1. A wireless transmit/receive unit (WTRU) comprising:
a processor configured to:
transmit a request to a plurality of AI-enabled machine vision (AI-MV) servers to perform inference on an AI-MV task associated with a machine vision application;
receive configuration information for a plurality of inference modes, wherein the configuration information comprises network resource availability for executing the AI-MV task for each of the plurality of inference modes and processing capabilities of the plurality of AI-MV servers;
select an inference mode from the plurality of inference modes based on the configuration information, network conditions detected by the WTRU, and resource availability at the WTRU;
transmit an indication of the selected inference mode to the plurality of AI-MV servers;
transmit data related to the AI-MV task to the plurality of AI-MV servers for processing in accordance with the selected inference mode;
receive an inference result from at least one AI-MV server of the plurality of AI-MV servers generated in accordance with the selected inference mode; and
perform a follow-on action based on the inference result.

2. The WTRU of claim 1, wherein, to perform the follow-on action, the processor is configured to detect an object, classify an object, track an object, adjust a navigation path of a vehicle, or modify a speed of a vehicle.

3. The WTRU of claim 1, wherein the inference result comprises information indicating classifications, detections, or identifications of objects detected in an environment surrounding the WTRU.

4. The WTRU of claim 1, wherein the network conditions detected by the WTRU comprise one or more of latency, jitter, bandwidth availability, or signal strength detected at the WTRU during communication with the plurality of AI-MV servers.

5. The WTRU of claim 1, wherein the data related to the AI-MV task comprises one or more of sensor input data from the WTRU, metadata associated with the input data, or task-specific parameters identifying the AI-MV task and associated sub-tasks.

6. The WTRU of claim 1, wherein the processor is configured to determine whether to execute the AI-MV task locally at the WTRU, remotely at one or more AI-MV servers of the plurality of AI-MV servers, or in a split manner across the WTRU and the one or more AI-MV servers of the plurality of AI-MV servers to select the inference mode from the plurality of inference modes, wherein the plurality of inference modes comprises a local inference mode, a remote inference mode, and a split inference mode.

7. The WTRU of claim 1, wherein the configuration information comprises information regarding available codecs at the WTRU or within the network; and
wherein the processor is configured to select the inference mode based on codec performance criteria.

8. The WTRU of claim 1, wherein the processor is configured to:
select the inference mode based on energy consumption levels observed in prior inference operations; and
select the inference mode based on a confidence level achieved in a previous MV task result generated by the MV task AI model.

9. The WTRU of claim 1, wherein the processor is configured to communicate with one or more AI-MV servers of the plurality of AI-MV servers to offload portions of the AI-MV task for processing in a split inference mode.

10. The WTRU of claim 9, wherein the processor is configured to transmit a first portion of the AI-MV task to a first AI-MV server of the plurality of AI-MV servers and receive an inference result that corresponds to the first portion of the AI-MV task processed by the first AI-MV server of the plurality of AI-MV servers.

11. A method implemented by a wireless transmit/receive unit (WTRU), the method comprising:
transmitting a request to a plurality of AI-enabled machine vision (AI-MV) servers to perform inference on an AI-MV task associated with a machine vision application;
receiving configuration information for a plurality of inference modes, wherein the configuration information comprises network resource availability for executing the AI-MV task for each of the plurality of inference modes and processing capabilities of the plurality of AI-MV servers;
selecting an inference mode from the plurality of inference modes based on the configuration information, network conditions detected by the WTRU, and resource availability at the WTRU;
transmitting an indication of the selected inference mode to the plurality of AI-MV servers;
transmitting data related to the AI-MV task to the plurality of AI-MV servers for processing in accordance with the selected inference mode;
receiving an inference result from at least one AI-MV server of the plurality of AI-MV servers generated in accordance with the selected inference mode; and
performing a follow-on action based on the inference result.

12. The method of claim 11, wherein the follow-on action comprises one or more of detecting an object, classifying an object, tracking an object, adjusting a navigation path of a vehicle, or modifying a speed of a vehicle.

13. The method of claim 11, wherein the inference result comprises information indicating classifications, detections, or identifications of objects detected in an environment surrounding the WTRU.

14. The method of claim 11, wherein the network conditions detected by the WTRU comprise one or more of latency, jitter, bandwidth availability, or signal strength detected at the WTRU during communication with the plurality of AI-MV servers.

15. The method of claim 11, wherein the data related to the AI-MV task comprises one or more of sensor input data from the WTRU, metadata associated with the input data, or task-specific parameters identifying the AIMV task and associated sub-tasks.

16. The method of claim 11, further comprising determining whether to execute the AI-MV task locally at the WTRU, remotely at one or more AI-MV servers of the plurality of AI-MV servers, or in a split manner across the WTRU and the one or more AI-MV servers of the plurality of AI-MV servers to select the inference mode from the plurality of inference modes, wherein the plurality of inference modes comprises a local inference mode, a remote inference mode, and a split inference mode.

17. The method of claim 11, wherein the configuration information comprises information regarding available codecs at the WTRU or within the network; and
wherein the inference mode is selected based on codec performance criteria.

18. The method of claim 11, further comprising:
selecting the inference mode based on energy consumption levels observed in prior inference operations; and
selecting the inference mode based on a confidence level achieved in a previous MV task result generated by the MV task AI model.

19. The method of claim 18, further comprising communicating with one or more AI-MV servers of the plurality of AI-MV servers to offload portions of the AI-MV task for processing in a split inference mode.

20. The method of claim 11, further comprising transmitting a first portion of the AI-MV task to a first AI-MV server of the plurality of AI-MV server and receiving an inference result that corresponds to the first portion of the AI-MV task processed by the first AI-MV server of the plurality of AI-MV servers.
